(19) United States
(12) Patent Application Publication
(10) Pub. No.: US 2012/0019464 A1
(43) Pub. Date: Jan. 26, 2012

(54) Touch Screen Friction Reducing Finger Caps

(75) Inventor: Richard DiDato, South Salem, NY (US)

(73) Assignee: Brain Box Concepts Inc., Amawalk, NY (US)

(21) Appl. No.: 13/188,296

(22) Filed: Jul. 21, 2011

Related U.S. Application Data
(60) Provisional application No. 61/366,163, filed on Jul. 21, 2010.

(51) Int. Cl. G06F 3/041; A41D 19/00

(52) U.S. Cl. 345/173; 2/163

(57) ABSTRACT

Finger gloves are provided for one or more fingers of the user of an electronic device with a touch screen. The finger gloves include a contact area made of a low-friction material.

### RELATED APPLICATIONS

This application claims priority to provisional application Ser. No. 61/366,163 filed Jul. 21, 2010 and incorporated herein in its entirety.

### BACKGROUND OF THE INVENTION

A. Field of Invention

This invention pertains to a finger cap or similar device used to make entries on an electronic device having a touch sensitive data entry input.

B. Description of the Prior Art

Touch screens have become a very popular means of data entry and/or data selection on many electronic devices, including smart phones, notebook computers, tablets, portable media players, toys, games, and so on. A problem with existing devices is that the build up of friction between the user's fingertips and the touch screen can become severe enough to diminish the functionality and value of the user's experience while operating touch screen applications which range from productivity to gaming.

### SUMMARY OF THE INVENTION

This invention pertains to a finger gloves arranged and constructed to be installed on the fingers of a person before the person activates the touch sensitive screen of an electronic device. The screen usually forms a graphic user interface through which the user can perform data entry, select and activate some keys, etc. Briefly, in accordance with this invention, the data finger includes a sleeve that covers at least a portion of the finger and is made of a material (such as) having a low coefficient of friction, especially with a plastic or glass material normally used for touch sensitive screens.

### BRIEF DESCRIPTION OF THE DRAWINGS

FIG. 1 is a side view of an index finger 15 showing the three individual phalanges 6, 8, & 10 which comprise the finger 15. The first phalange 10 is the most proximal to the hand 28 while the third phalange 6 is the most distal.

FIG. 2 is a top view of a right hand 28 without any of the friction eliminating finger covers 2 on the finger tips 6 & 12.

FIG. 3 is a side view of a thumb 17 showing the two individual phalanges 12 & 14 which comprise the thumb 17.

FIG. 4 is a side view of the primary invention 2 which is a finger cap/cover 2 designed to eliminate the friction between the user's finger tips 6 & 12 and capacitive or pressure touch screens 19, 20, & 24 commonly found on smart phones 20, iPads 24, or any other electronic device equipped with a touch screen. The invention 2 articulates with the tip 6 of the user's finger 15 and is made from nylon or other suitable materials. The length of this embodiment 2 runs from the distal end of the third phalange 6 to the proximal end of the third phalange 6 or to the middle of the second phalange 8 on the index finger 15. Here one can also see an elastic band 4 at the proximal end of the finger cap 2 which helps hold the invention 2 in the most desirable position on the user's finger tips 6 & 12.

FIG. 5 is a side view of an index finger 15 showing the invention 2, in a cross section side view, on the tip 6 of the user's finger 15.

FIG. 6 is a side view of an index finger 15 showing the friction eliminating finger cap 2 over the tip or third phalange 6 of the user's finger 15.

FIG. 7 is a side view of an index finger 15 with an alternate embodiment 18 of the invention 2 which covers the entire length of the finger 15 from the third 6 phalange to the first 10. This is useful when it's desirable to have more of the user's finger in contact with capacitive touch screens 19, 20, & 24.

FIG. 8 is a top view of a human right hand 28 showing the friction eliminating finger caps 2 on the tips of all five fingers.

FIG. 9 is a smart phone 22 or PDA device, with a capacitive touch screen 20, being operated by an index finger 15 with a friction eliminating finger cap 2 covering the third phalange 6 of the said finger 15.

FIG. 10 is an iPad or similar computer tablet 26, with a capacitive touch screen 24, being operated by the user's two thumbs 17 simultaneously while the invention 2 covers the tips 12 of both said thumbs 17. This is done while the user holds the computer tablet 26 with both of their hands 28.

FIG. 11 is an iPad or similar computer tablet 26, with a capacitive touch screen 24, being operated by the user's left thumb 17 and right index finger 15 and right thumb 17 while using the friction eliminating finger caps 2 to cover the tips 6 & 12 of the aforementioned fingers 15 & 17.

FIG. 12 is a flowchart showing a side view of the invention 2 by itself, then covering the third phalange 6 of an index finger 15, and finally showing the index finger 15, with the friction eliminating finger cap 2 covering the finger tip 6, operating the capacitive touch screen 20 of a smart phone 22 or multiple fingers 15 & 17, using the said invention 2, operating a larger screened 24 computer tablet 26.

FIG. 13 is an iPad or similar computer tablet 26, with a capacitive touch screen 24, being operated with the index fingers 15 of two different users simultaneously. Here one can see the index fingers 15 of the two separate user's interacting with the same touch screen 24 at opposite ends of the computer tablet 26 while utilizing the invention 2 to cover their finger tips 6.

FIG. 14 is an iPad or similar computer tablet 26, with a capacitive touch screen 24, being operated with the index fingers 15 of four different users simultaneously. Here one can see the index fingers 15 of the four separate user's interacting with the touch screen 24 at all four sides of the computer tablet 26 while utilizing the invention 2 to cover their finger tips 6. This situation, as in FIG. 13, is ideally suited for multiple people to use the friction eliminating finger covers 2 to simultaneously play a game together on the touch screen 24 of the computer tablet 26.

FIG. 15 is a TV 21 or computer monitor 21 with a much larger capacitive touch screen 19. Here the user could stand or sit in front of the large touch screen 19 while operating it with the friction eliminating finger caps 2 on one or all ten of their fingers depending on the interactive nature of the current program or task.

FIG. 16 shows a top view of an alternative embodiment 30, of the main invention 2, where instead of the cap/cover sliding over the user's fingers this embodiment 30 is shaped like a “band-aid” and folds over the top of the index finger 15 to lock into position by using Velcro 33A & 33B on the left topside 32A and the right bottom side 32B of the finger cap 30. Here, the nylon material 34 used to eliminate the friction between the user's finger tip 6 and the capacitive touch screens 19, 20, & 24 sits between the two sections 32A & 32B of Velcro 33A & 33B or similar material.

FIG. 17 is the same as FIG. 16 with the exception of showing an alternative embodiment 30 of the invention 2 from a bottom view where one can see the Velcro 33B on the other side 32B of the finger cap 30 while still seeing the non-friction material 34 at the center.

FIG. 18 is a flowchart showing first the “band-aid” styled friction eliminating finger cap 30 by itself in an open position, second the third phalange 6 of an index finger 15 positioned in the center 34 of the finger cap 30, and third the finger cap 30 closed over the tip 6 of the user's index finger 15.

FIG. 19 is another alternative embodiment of the primary invention 2 showing a top view of its composition. Here one can see a thicker piece of material 42 (possibly soft plastic) outlining the perimeter of the finger cap 36 and a thin piece of nylon material 38 partially extending outward from the distal towards the proximal end of the finger cap 36 to help secure the cap in position over the top 6 of the user's finger 15. One can also see nylon 40, or similar material which produces the same friction eliminating results, attached to the thicker perimeter material 42 as it ranges across the diameter of the finger cap 36; this area 40 of the finger cap 36 creates the barrier between the user's finger tip 6 and the touch screens 19, 20, & 24.

FIG. 20 is a side view of the alternative embodiment 36 found in FIG. 19.

FIG. 21 is a side view of the alternative embodiment 36 found in FIG. 19 where one can see the third phalange 6 of the index finger 15 situated inside the finger cap 36. Here, most of the top of the finger tip 6 remains exposed while just the fingernail is covered by a piece of thin material 38 to help hold the friction eliminating finger cap 36, along with the thicker perimeter material 42, in its proper place.

FIG. 22 is front view of another embodiment 44 of the invention 2 which employs a ring 46, made from soft plastic or a fabric, with a nylon sheet 48 attached across the diameter of the ring 46.

FIG. 23 is a side view of the alternative embodiment 44 found in FIG. 22 where one can see the friction eliminating nylon material 48 extending slightly past the ring 46 from where it's connected.

FIG. 24 is a side view of the alternative embodiment 44 found in FIG. 22 where one can see the friction eliminating nylon material 48 stretched out over the third phalange 6 of the user's index finger 15.

FIG. 25 is a bottom view of an alternative embodiment 54 of the invention 2 which does not follow the circumference of the finger tip 6; instead, it sticks to the tip 6 of the user's finger 15, like a large dot, at which point the bottom side 50 of “stick-um” circle 54 can be used to eliminate the friction between the tip 6 of the user's finger 15 and capacitive touch screens 19, 20, & 24.

FIG. 26 is a top view of the alternate embodiment 54 of the invention 2 found in FIG. 25; here one can see an adhesive material 52 made from either a nontoxic glue or a material which binds naturally to human skin.

FIG. 27 is a bottom view of an index finger 15 revealing the bottom side 50 of the “stick-um” circle embodiment 54 of the invention 2 adhered to the bottom tip 6 of the user's finger 15.

FIG. 28 is a top view of an alternate embodiment 56 of the invention 2 which doesn't use any nylon or similar material to cover the user's fingers 15 & 17. Instead, a specialized touch screen cover 56, made mostly from silicone, is used to reduce the friction between the user's fingers 15 & 17 and the touch screens 19, 20, & 24.

FIG. 29 is a flowchart showing the touch screen cover alternative embodiment 56 from FIG. 28, which doesn't cover the user's fingers 15 & 17 at all, removed from a smart phone touch screen 20, then securely positioned over the smart phone/PDA touch screen 20, and then the user's index finger 15 operating the touch screen 20 without a finger cap 2 over the tip 6 of the said finger 15.

FIG. 30 is a plastic clamp 58 designed to attach to capacitive touch screen equipped computer tablets 26 or any other device with a touch screen 19, 20, 24. The clamp 58 has a friction eliminating finger cover 66 connected to it via a retractable string 64 which allows the user to quickly place the cap 66 over their finger tip 6 for friction free use of the touch screen 19, 20, 24. When the user is done they can quickly remove the finger cap 66 while keeping it attached to their computer tablet 26 for immediate use.

FIG. 31 is a computer tablet 26 with the clamp 58 from FIG. 30 attached to it.

FIG. 32 is a flowchart showing the clamp 58 with the finger cover 66 connected to it, then a touch screen computer tablet 26 with the clamp 58 attached to it, and finally a user's finger tip 6 inside the friction free finger cover 66, extending away from the clamp 62 via the retractable string 64, operating the touch screen 24.

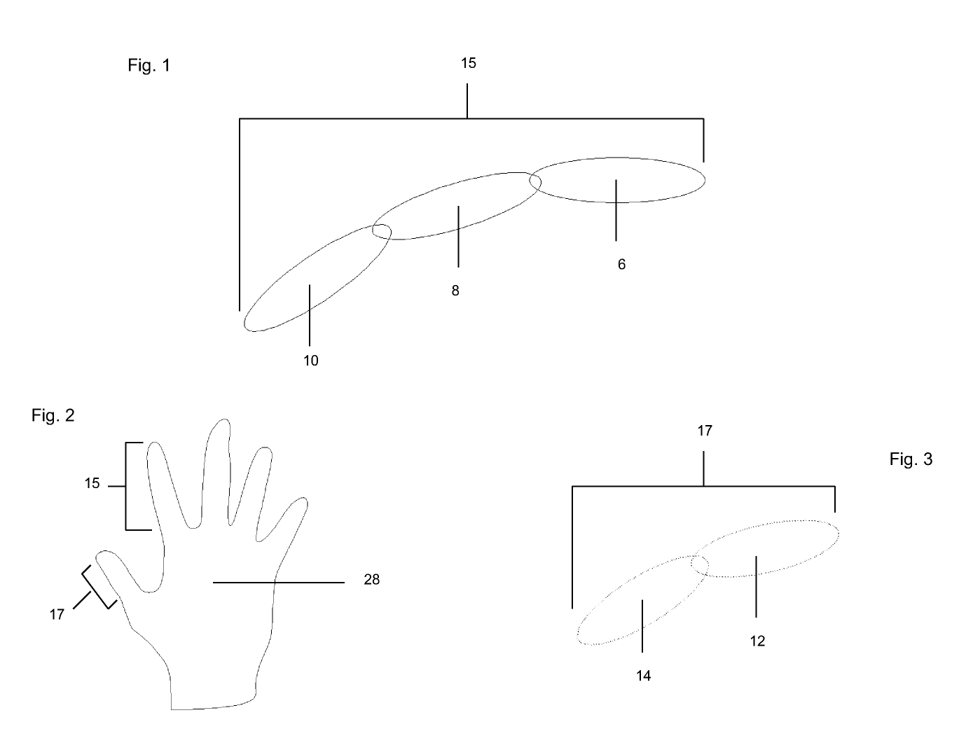

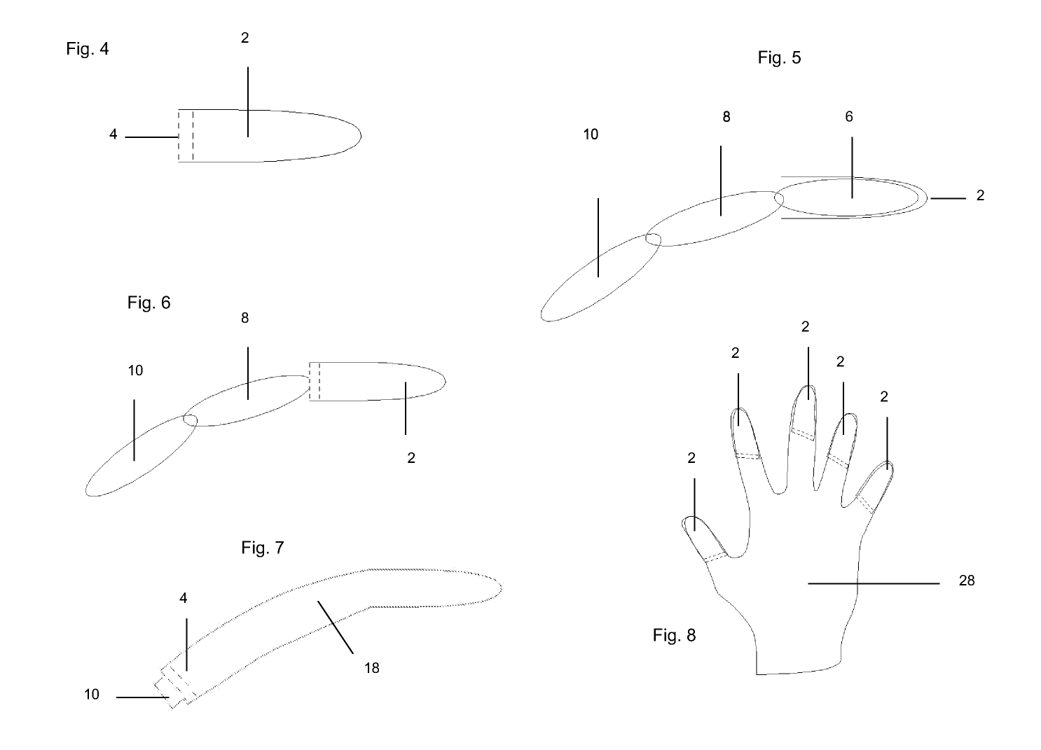

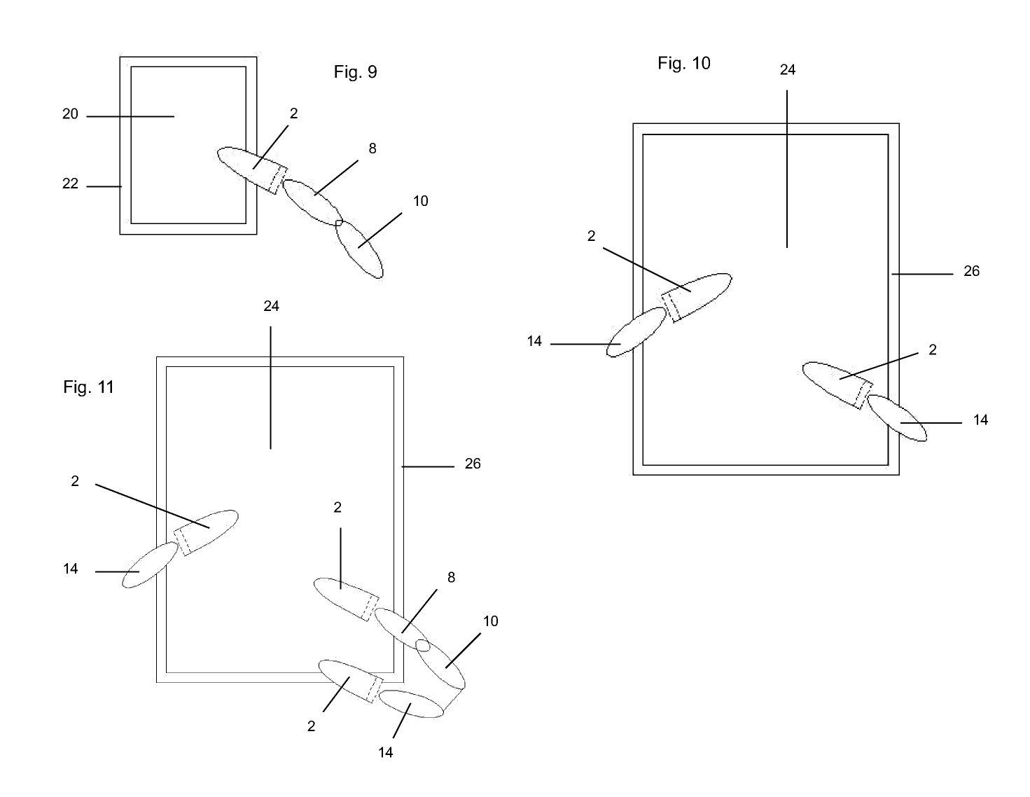

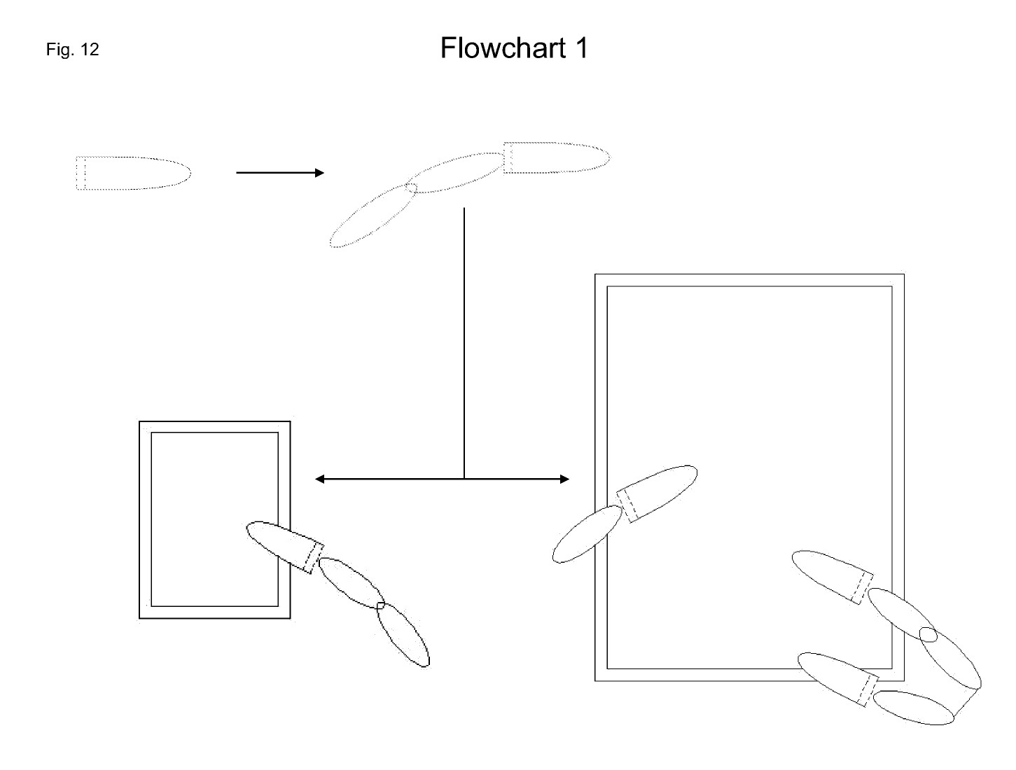

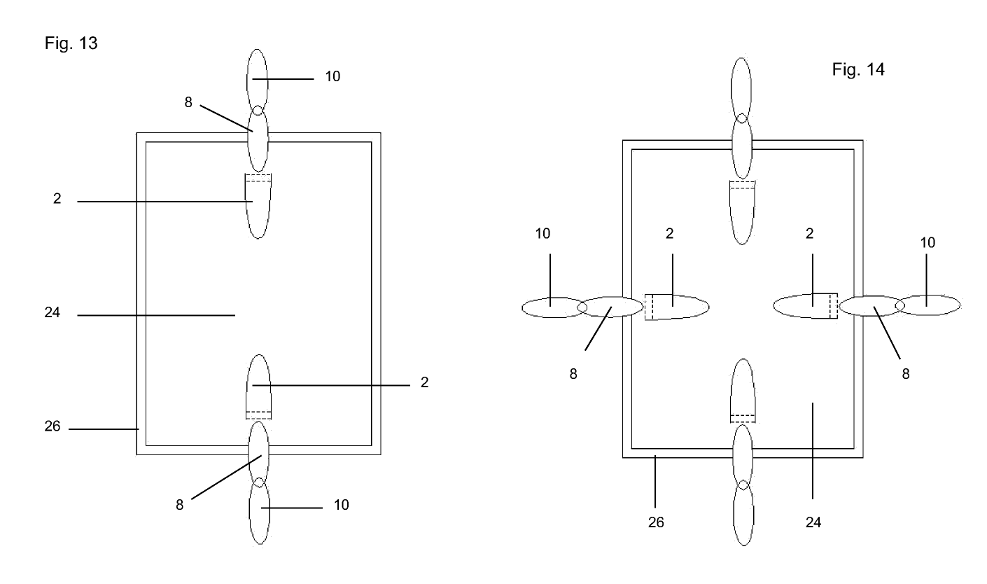

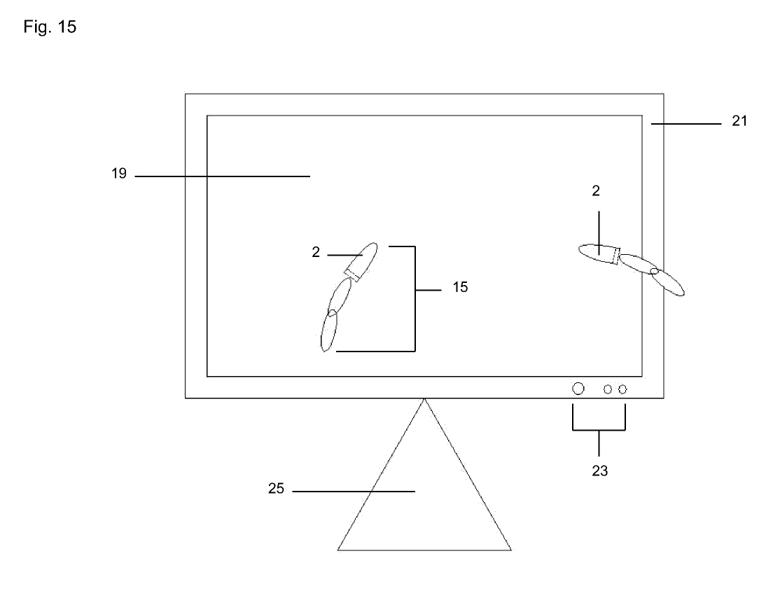

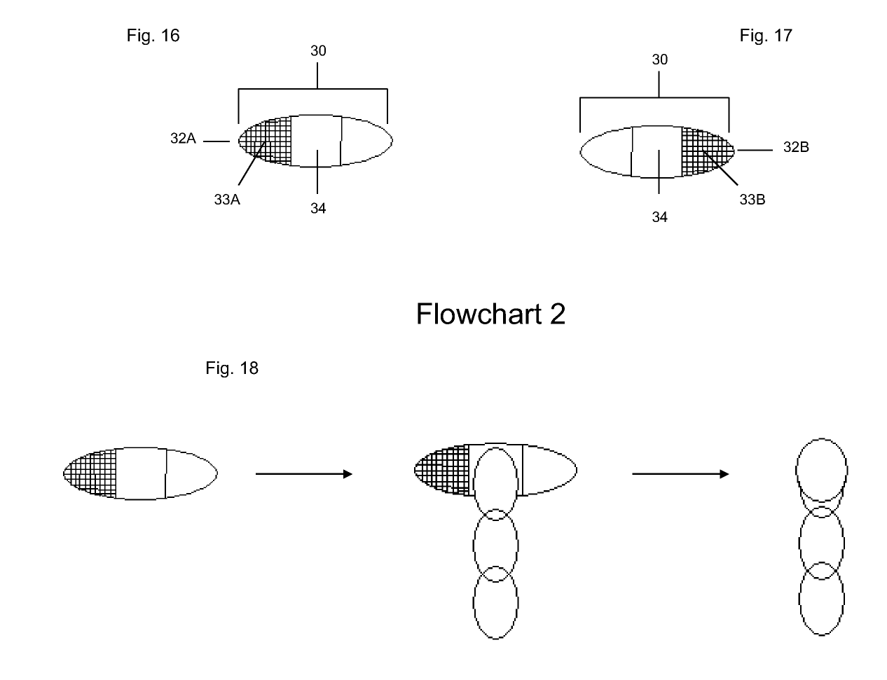

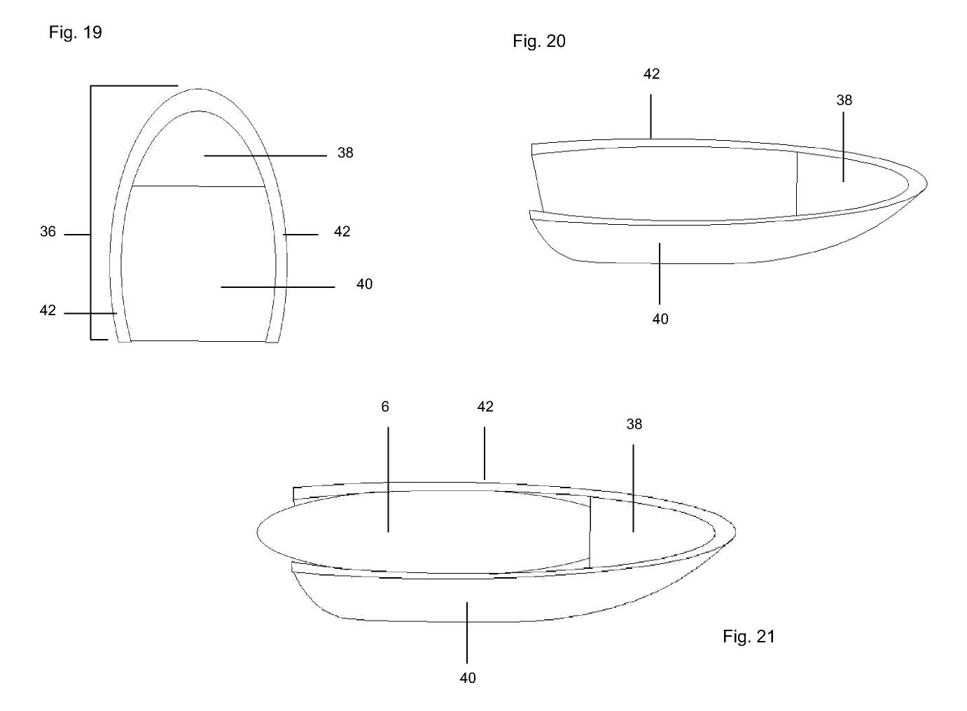

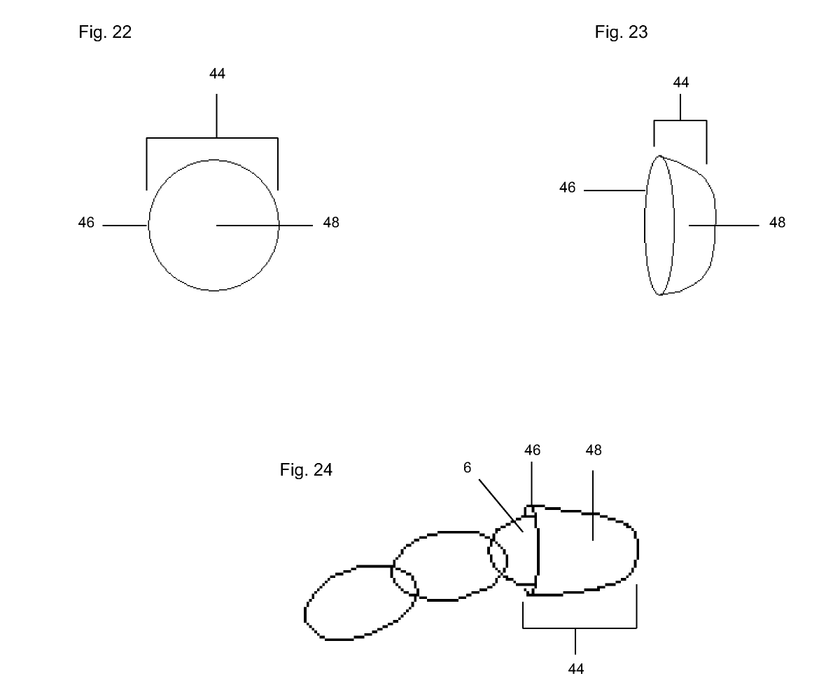

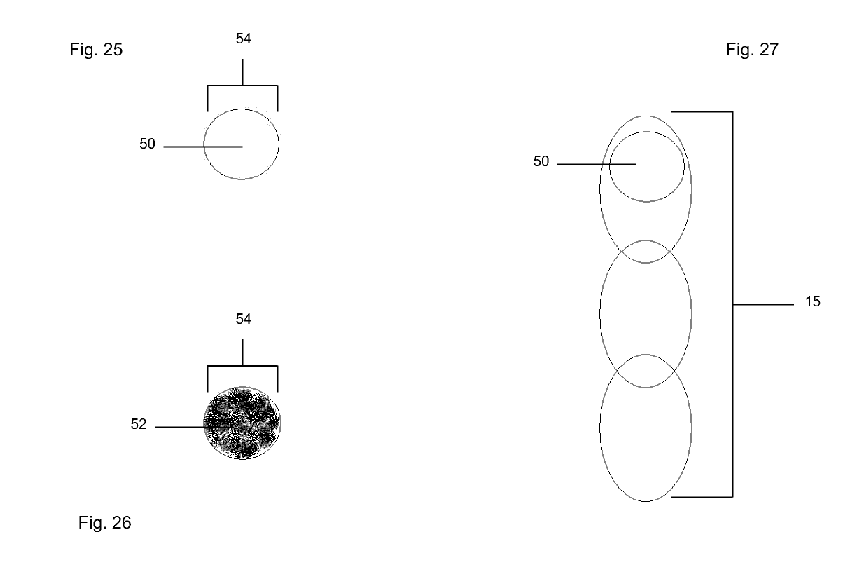

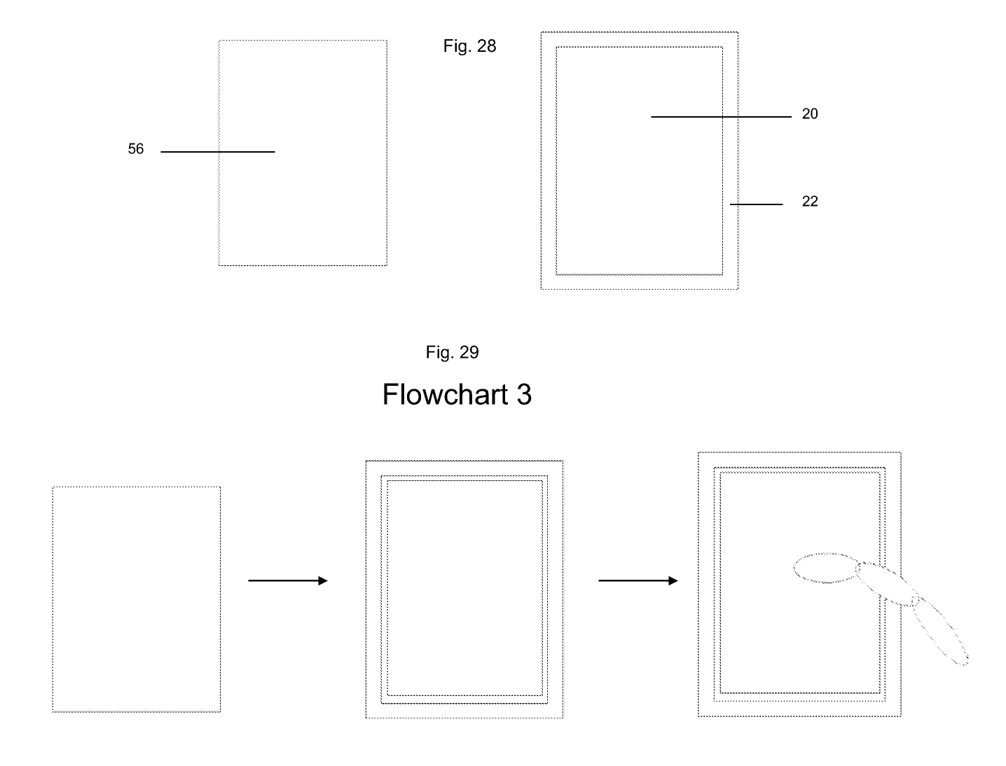

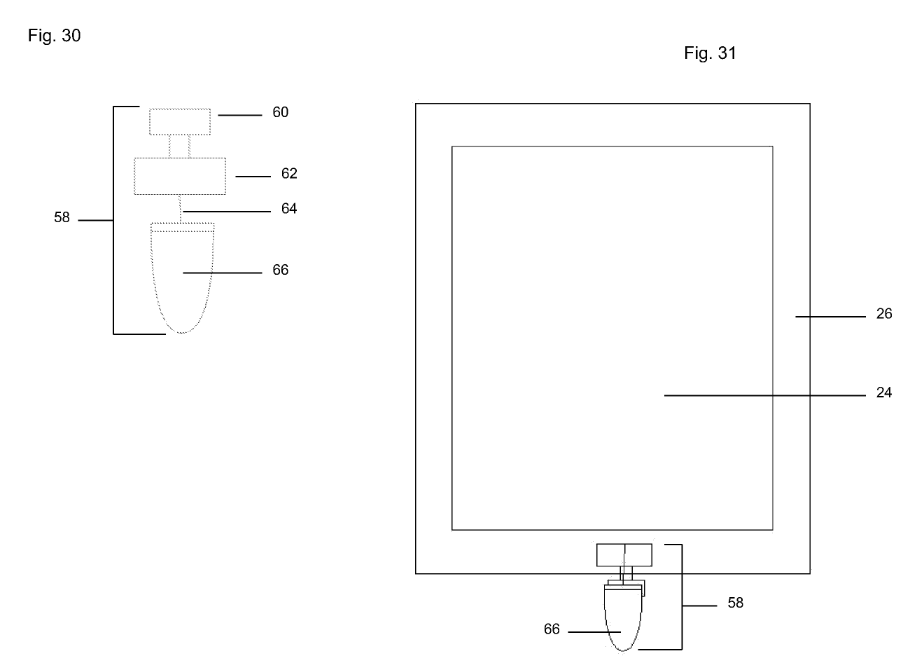

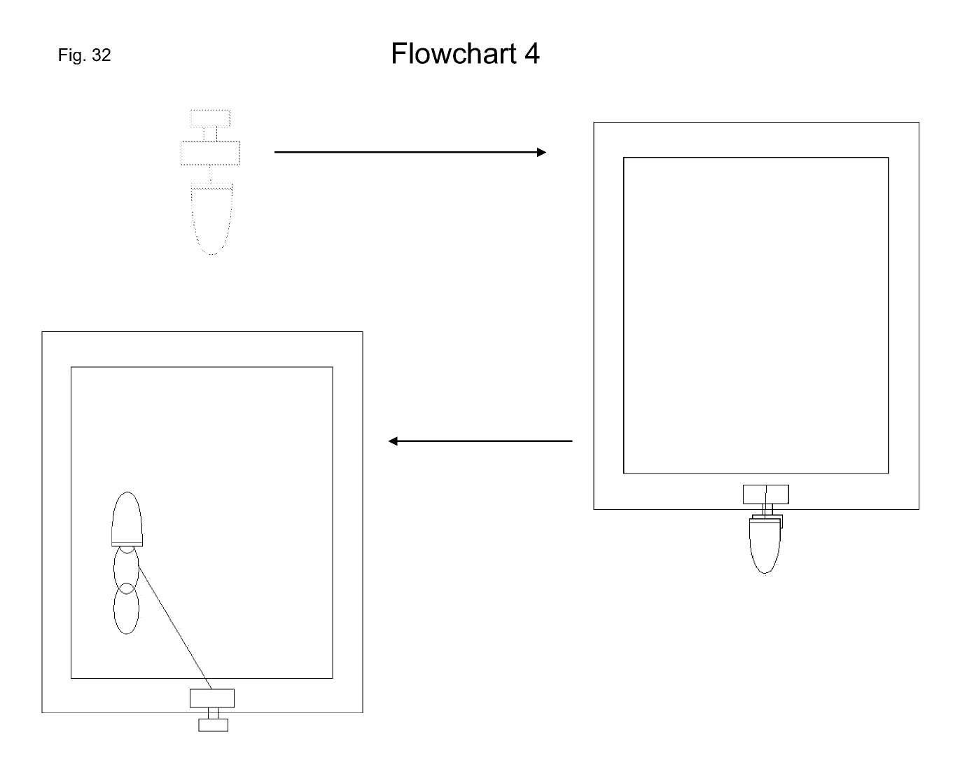

### DETAILED DESCRIPTION OF THE INVENTION

I have invented friction eliminating/reducing finger caps 2 which allow consumers to operate capacitive and pressure touch screens 19, 20, & 24 without the interference of restrictive friction between the user's finger tips 6 & 12 and the surface of touch screens 19, 20, & 24. I have invented these new friction eliminating finger caps 2 to enhance the fundamental experience for the user when operating electronic devices like smart phones 22, PDA's, laptops, and tablets (such as the iPad) 26 which commonly use touch sensitive screens 19, 20, & 24 as their primary user interface for the operation of the said electronic devices. However, the application of the invention 2 isn't limited to touch screens 19, 20, & 24 found on smart phones 22 and computer tablets 26.

To achieve these results I used material, mostly nylon but not limited to said material, to construct a finger cap 2 which eliminates or greatly reduces the friction coefficient between the user's fingers 15 & 17 and capacitive touch screens 19, 20, & 24. The nylon, or other specialized thin breathable material, is intended to primarily cover the tip 6 of the user's index finger 15 and thumb 17 from the distal to the proximal end of the third phalange 6 on the pointer finger 15 and the second phalange 12 on the thumb 17. The finger cap 2 creates a thin barrier around the tip 6 of the user's finger 15 which facilitates the friction eliminating utility of the invention 2 while allowing the user's finger 15 to interact with the capacitive touch screens 19, 20, & 24 in a traditional manner; i.e. the electromagnetic interaction between the user's finger tip 6 and the capacitive screens 19, 20, & 24 is not diminished. The finger caps/covers 2 can be utilized on any of the five finger tips found on a typical hand 28. It maybe desirable to extend the length of the finger cover 18 to include the entire finger 15 from the first 10 to the third phalange 6 if the user whishes to bring a larger surface area of their finger 15 in contact with the touch screens 19, 20, & 24.

The invention 2 performs its indented utility very well when it's made from ultra thin nylon; however, construction of the “Finger Caps” 2 is not limited to the said material. Optimally, the material of the finger caps 2 should be as thin as possible while not being weak enough to break or tear under the necessary stress of operating the capacitive touch screens 19, 20, & 24.

The invention 2 is especially useful on larger touch screens 24 like the iPad or any other competing computer tablet 26 equipped with a touch screen 24 where the user has a significantly larger glass surface area 24 to slide their fingers 15 across which inevitably creates unwanted friction for the user if they're not using the finger caps 2. The utility of the friction eliminating finger caps 2 are also applicable to the touch screens 19 of large stationary PC monitors 21, TV's 21, as well as the small capacitive touch screens 20 found on mobile devices like smart phones 22 or any other form of PDA device 22. Also, warm humid weather makes it especially difficult for touch screen 19, 20, & 24 users to slide their fingers 15 across the said screen without creating considerable friction due to the humidity. The invention 2 allows the touch screen user to manipulate their fingers 15 across the screen 19, 20, & 24 without suffering the detrimental effects of operating the said device under warm humid conditions

The invention 2 reduces substantially or eliminates the natural friction which occurs between a user's finger tips 6 and touch screens 19, 20, & 24 commonly found on smart phones 22 and computer tablets 26 like the iPad. However, the value and application of the invention 2 is not limited to the said electronic devices; the finger caps 2 could also be very useful for electronic devices dedicated to entertainment applications, like touch screen handheld gaming systems, or to business productivity applications. The specialized finger caps 2 also provide the same aforementioned benefits to regular electronic touch screens which rely on finger pressure to manipulate the onscreen icons instead of the electromagnetic sensitivity between a finger 15 and capacitive touch screens 19, 20, & 24.

The invention 2 facilitates additional value by keeping the touch screen 19, 20, & 24 significantly cleaner as a result of the user's finger tips 6 not coming into direct contact with the said screen 19, 20, & 24, which, at a minimum, keeps oil and contaminants on the skin of the user's finger 15 from reaching the surface of the touch screen 19, 20, & 24.

The friction reducing finger cap 2 is designed to fit securely over the tip 6 of the user's fingers 15 & 17 by being narrow enough to form fit around the circumference of the user's fingers 15 & 17 while not being constrictive to the point where it becomes uncomfortable for the wearer. A thin elastic band 4, situated at the proximal end of the cap 2, can also be utilized to ensure optimal positioning on the user's fingers 15 & 17 during use. The elastic band 4, in the same manner as the body of the invention 2, will not be too constrictive on the user's finger 15 in-order to prevent it from becoming uncomfortable during extended periods of use.

Another embodiment 30 of the invention 2 works similarly to a Band-Aid where the user places the tip 6 of their finger 15 in the center 34 and then folds one side 32A of the cap 30 over the other 32B which renders the finger cap 30 functional for its intended utility of frictionless finger operation of capacitive touch screens 19, 20, & 24. A light Velcro 33A & 33B or other binding material is used to hold each half 32A & 32B of the finger cap 30 in a locked position when one side 32A is pressed on the other 32B. Also, the distal end of the finger cap 30 is shaped to curl up which helps naturally conform to the shape of the tip 6 of the user's finger 15.

Another embodiment 36 of the invention 2 uses a thicker material 42, possibly flexible plastic, which outlines the top portion 42 of the cap 36 while connecting the same ultra thing nylon material 40 to the bottom of the finger cap 36. This embodiment 36 allows the user to slide their finger 15 into the cap 36 while the dorsal side of their finger tip 6 remains untouched by any material except for a small section 38 at the distal topside of the finger cover 36, which is intended to help secure the finger cover 36 on the tip 6 of the user's finger 15.

Another embodiment 44 has a ring 46, which follows the circumference of the finger 15, with the friction eliminating material 48 lying almost flat across the diameter of the ring 46; when the user pushes the tip 6 of their finger 15 through the ring 46 the material 48 stretches around the user's finger 15. At this point, the “ring” embodiment 44 of the invention 2 can be used to operate capacitive touch screens 19, 20, & 24 without the annoyance of friction building up between the tip 6 of their finger 15 and the touch screens 19, 20, & 24.

Yet another embodiment 54 of the invention 2 doesn't encase the tip 6 of the finger 15 by surrounding its circumference with a friction reducing cap 2; instead, a little “stick-um pad” 54 is adhered to the tip 6 of the user's finger 15 via some form of glue 52 or some naturally binding material 52 which sticks to the user's skin. The stick-um pad 54 has the same friction reducing properties 50 of the main invention 2 on its bottom side 50 and can be shaped in the form of a circle or any other geometric shape which makes sense to cover the ventral side of the tip 6 of the user's finger 15.

The construction and material of the invention 2 is so thin and light that it feels as though there is nothing on the wearer's finger 15 which makes the finger caps 2 ideally suited to be worn for extended periods of time.

The invention 2, for aesthetic purposes, can have decorative designs around the circumference of the finger caps 2. The decorative imprints can range from the logo of the product to promotional designs of other companies.

A storage area, designed to accommodate the “Finger Caps” 2 when they're not in use, can be built into the body of any smart phone's protective cover/case. The storage utility compliments the functionality of the core invention 2 well by not only making the finger caps 2 readily accessible but also reducing the user's probability of losing them. The addition and utilization of a small compartment on a cell phone case is not limited to the storage of the finger caps 2; any number of small items could be placed there for accessible storage. Also, the size of the storage compartment can range from postage size to the length of the case.

The majority of the prior art focuses on covering a portion of the user's finger 15 or hand 28 for the purpose of augmenting data entry. For example, the finger tip cover, seen in patent # US 2009/0289893 A1, is designed to assist the user's ability and precision to punch or strike computer keys. The prior art accomplishes this by using a blunt member at the tip of the finger cover which can be ribbed to produce “high friction” when making contact with the electronic device's keys. It's desirable for the surface of the prior art to be uneven at its center while using material which exhibits increased friction characteristics. The aforementioned attributes of the prior art are in absolute contrast to the thin smooth non-friction producing characteristics of our invention 2. Problems with the data entry finger appliance include:
The surface of the finger cap is uneven or asymmetrical which doesn't translate well for use with electronic touch screens.
The data entry finger cover is constructed out of high friction producing materials which don't have application for electronic devices with touch screens.
The design of the data entry finger cap leaves most of the user's finger tip exposed, on the bottom or ventral side, which creates the tactile friction our invention is endeavoring to eliminate between touch screens and the user's fingers.

Other prior art, such as patent # US 2007/0245454 A1, places a stylus or rounded point on a glove at the tip of the wearer's pointer finger 15. This is done to allow workers in a ware-house to use hand protection in freezing conditions while still being able to interact with control pads and screens. The stylus equipped glove allows the worker to make data entries while keeping their hands 28 safe from the freezing temperatures. Problems with the stylus cold weather glove include:
The thickness of the glove would prevent or severely inhibit the capacitive touch functionality between the user's fingers and the screen.
The stylus attached to the tip of the glove's index finger may have some limited effect on a pressure touch screen but it wouldn't yield any beneficial or purposeful results for the user of a capacitive touch screen, which renders the glove useless for our intended utility.
Further, the wearer's hand would become unbearably hot when using the glove in any temperatures other then very cold or freezing.

More prior art, U.S. patent application # US 2003/0174124 A1, uses a different methodology of allowing the user to manipulate the onscreen functionality of an electronic device by adding computer mouse control to a user's finger tip 6. To produce this effect a trackball is situated at the tip of the finger cap/cover so the trackball can be operated by the other fingers on the user's hand 28. Problems with the finger tip trackball for touch screens include:
The finger tip trackball would render a touch screen device inoperable by the awkward placement of the trackball at the tip of the user's finger.
The size and placement of the trackball would drastically reduce the user's ability to type or perform other necessary functions with their electronic device due to the cumbersome nature of the trackball finger cover.

Other prior art (U.S. Pat. No. 4,931,782) sets out to shield the touch screen of an electronic device from scratching and damage by encasing it with an extra layer of laminate material. This approach is a suitable method of adding a protective buffer layer to the touch screen; however, it doesn't reduce the friction which builds up between the user's fingers 15 and the screens 19, 20, & 24 when they're not using a stylus to manipulate the onscreen icons. Problems with the extra layer of protective material on a touch screen include:
The extra layer of laminate material still builds up friction when the user manipulates the touch screen with their fingers.
The extra layer of protective material is intended to be used on primarily on pressure sensitive touch screen which employ the use of a stylus to manipulate the onscreen of functionality of the device. The consumer demand for pressure sensitive touch screens is fading while the demand for capacitive touch screens is dramatically increasing.

Our finger cover/cap 2 is preferable to the prior art referenced in U.S. patent application # US 2009/0289893 A1 as our invention 2 uses ultra thin non-friction producing materials, like nylon, which allow the wearer to glide their finger tips 6 across touch screen 19, 20, & 24 equipped electronic devices 21, 22, & 26 for the purpose of manipulating the onscreen user interface to yield a desirable result. The prior art leaves large portions of the user's finger 15 uncovered which produces friction between the user's finger 15 and the touch screen, whereas, our finger cap 2 prevents any aspect of the user's finger tip 6 from coming in direct contact with the touch screens 19, 20, & 24.

The demonstrative benefit of our invention 2 over the prior art found in U.S. patent application # US 2007/0245454 A1 is measurably apparent. Fore example, our finger cover 2 is designed to be as thin as possible to allow air to pass through the material as if the user doesn't have anything on the tip 6 of their fingers 15 which prevents the user's fingers 15 from becoming over heated during use. The ultra thin nature of our invention 2 also facilitates unimpeded functionality between the capacitive touch screens 19, 20, & 24 and the user's fingers 15 so precise control, while operating the screen icons, is maintained effortlessly. Lastly, it's just not practical to have a glove covering the entire hand 28 of the user when only the tips 6 of the user's fingers 15 are required to operate an electronic device 21, 22, & 26 equipped with a touch screen 19, 20, & 24.

Our invention 2 has advantages over the prior art (patent application # US 2003/0174124 A1) by allowing the user to wear our non-friction producing finger caps 2 while still maintaining full dexterity over their fingers 15 and hands 28 to interact with the electronic devices without restriction to type or perform any other standard functionality.

One of our radical alternative embodiments of the invention 2 affords the user greater benefit over the prior art (U.S. Pat. No. 4,931,782) by not only adding an extra layer of protective material 56 to the surface of the touch screen 20 but also by producing the material from a substance, e.g., silicone based, which is friction reducing to the touch of the user's fingers 15. As a result, the user enjoys “reduced” friction between their finger tips 6 and the screen 20 without having to wear the main embodiment of our invention 2, which is a friction “eliminating” finger cap 2.

The components of the invention are:
2 is the body of a friction eliminating/reducing cover which articulates with the tips 6 & 12 of the user's fingers 15 & 17.
4 is the stitching of an elastic border which follows the circumference of the finger cap 2 at its proximal end to prevent the invention 2 from moving out of its optimal position on the user's fingers 15 &17.
6 is the third phalange of a human index finger but can also represent the third phalange of the other four fingers found on the hand 28.
8 is the second phalange of a human index finger 15 but can also represent the second phalange of the other four fingers found on the hand 28.
10 is the first phalange of a human index finger 15 but can also represent the first phalange of the other four fingers found on the hand 28.
12 is the second phalange of a human thumb 17.
14 is the first phalange of a human thumb 17.
15 is the entire index finger.
17 is the entire thumb.
18 is an extended version of the main embodiment of the invention 2 where the length of the friction eliminating finger cap 18 is extended to cover from the third phalange 6 to the first phalange 10 on the index finger 15 or other fingers on the hand 28.
19 is the capacitive/pressure touch screen of stationary PC monitor 21; this could also represent the touch screen 19 of a stationary TV 21.
20 is the capacitive touch screen of an electronic smart phone device 22.
21 is the body or perimeter of the PC/TV monitor with a capacitive/pressure touch screen 19.
22 is the body of a smart phone.
23 are the power and volume buttons found on the body of the TV/monitor 21.
24 is the capacitive touch screen of a computer tablet like the iPad or similar devices 26. The capacitive touch screens 24 found on computer tablets 26 are measurably larger then the screens 20 found on smart phones 22.
25 is the stand which supports the PC monitor/TV 21 at its base.
26 is the body of a computer tablet like the iPad or similar device.
28 is a human hand showing all five fingers.
30 is the body of an alternate embodiment of the invention 2 which closes like a band-aid over tip 6 of the user's finger 15.
32A is left topside of a Velcro adhesive section 33A found on the band-aid embodiment 30 of the friction reducing finger cap 2.
32B is right bottom side of a Velcro adhesive section 33B found on the band-aid embodiment 30 of the friction reducing finger cap 2.
33A is the Velcro material which comprises the left topside 32A of the “band-aid” embodiment 30 of the invention 2.
33B is the Velcro material which comprises the right bottom side 32B of the “band-aid” embodiment 30 of the invention 2.
34 is the non-friction nylon section of the “band-aid” embodiment 30 of the finger cap.
36 is the body of an alternate embodiment of the invention 2 which uses thicker material to outline the perimeter 42 of the topside of the finger tip 6, which holds this embodiment 36 of the invention 2 in place, while using the friction eliminating material 40 to cover the tip 6 of the user's finger 15.
38 is a thin layer of material which helps prevent the alternate embodiment 36 of the invention 2 from falling off the user's finger 15.
40 is the nylon or other suitable friction eliminating material which is positioned to cover the bottom tip 6 of the user's finger 15.
42 is a section of thicker material which outlines the topside of the finger tip 6 to keep the finger cap 36 in its appropriate position.
44 is the body of an alternate embodiment of the invention 2 which uses a thicker piece of the material, which has flexibility, to form a ring 46 with the non-friction nylon material 48 across its diameter.
46 is a ring which fits over the tip 6 of the user's finger 15 and is found on an alternative embodiment of the invention 44.
48 is the nylon or other suitable friction eliminating material which is positioned to cover the tip 6 of the user's finger 15.
50 is the bottom side of the “stick-um” embodiment for the finger tip which is made from the friction eliminating material (typically nylon).
52 is the topside of the “stick-um” cap for the finger tip which uses glue or a material that is naturally binding to human skin to maintain its position on the finger tip 6.
54 is the body of the alternate embodiment of the invention 2 where, in place of a finger cover 2 which follows the circumference of the user's finger 15, a little “stick-um” circle 54 is used to cover only bottom side of the tip 6 of the user's finger 15.
56 is a silicone based screen cover designed to reduce the friction between the user's finger tips 6 and the screen 20 of a smart phone/PDA 22.
58 is the body of a clamp 62 with a special version 66 of the friction eliminating finger cover 2 attached to it via a retractable string 64.
60 is the section of the clamp 58 the user squeezes to open the opposing mouth 62 of the clamp 58 which articulates with the body of an iPad 26, other computer tablets 26, or any electronic device equipped with a large capacitive touch screen.
62 is the mouth of the clamp 58 which attaches to the body of any electronic device equipped with a capacitive touch screen. The inside of the “clamp mouth” 62 is lined with rubber or other soft material as to not scratch the electronic device it's attached to.
64 is a retractable string which is connected to the clamp 62 and the friction eliminating finger cover 66.
66 is a friction eliminating finger cover which is attached to a retractable string 64.
Basic components include: For the non-friction producing areas of the finger caps desirable materials such as nylon, cotton, or any other soft breathable material which is organic or synthetic in nature could be used to yield the desired result. Other materials used in the construction of the invention could include Velcro, plastic, glue, string, rubber, silicone, and elastic materials.

The method or arrangement for these components includes combining various layers of specialized material which provide for a nonabrasive bottom to the friction eliminating finger covers 2, 18, 30, 36, 44, 54, & 56.

The main embodiment of the invention 2 form fits to cover the user's finger tip 6 while using an elastic band 4, which follows the circumference of the user's finger 15, at its proximal end to ensure further stability during use. This holds true for the alternate embodiment 18 of the invention 2 which is extended in length to cover all three phalanges 6, 8, & 10 of the index finger 15.

The alternative embodiment 30, which is shaped like a “band-aid”, has a nylon center which is attached on the left 32A and right 32B sides to Velcro.

The alternate embodiment 36, which uses thicker material 42 around the perimeter of the finger tip 6, has nylon attached across the entire diameter of the finger cover 36. Also, there is a small section of nylon attached to the top distal end of the finger cover 36 to help hold it in position on the user's finger tip 6.

The finger cover has another embodiment 44 which uses a ring 46, made from plastic or thickened fabric, with nylon 48 reaching across the diameter of the ring 46. The user slides the ring 46 over the tip 6 of their finger 15 to extend the nylon 48 into position.

Another embodiment 54 doesn't cover the user's finger 15; instead it sticks to the tip 6 of the user's finger 15 via glue or naturally binding material 52 which adheres to human skin.

A radically different embodiment 56 of the invention 2 uses a silicone based material which attaches to a touch screen 20 of a smart phone/PDA 22.

Yet another embodiment 58 of the invention 2 connects a friction eliminating finger cover 66 to a clamp 62, via a retractable string 64, whereby, the clamp 62 can be attached to the body of an electronic device 21, 22, & 26 equipped with a touch screen 19, 20, & 24.

The friction eliminating finger cover 2 achieves its result as follows: One or several finger covers 2 are removed from the packaging; at which point the user pulls or rolls the finger cover 2 into position over the third phalange 6 of any of the four primary fingers found on a typical hand 28. The same process can be applied to covering the second phalange 12 of the thumb 17. Once the friction eliminating finger cover 2 is properly situated over the user's finger tips 6 & 12 the user can initiate contact between their finger tips 6 & 12 and the capacitive touch screens 19, 20, & 24 without diminishing the sensitivity of the electromagnetic connection between the said fingers 6 & 12 and screens 19, 20, & 24. The finger cover's 2 lightweight and breathability enable the user to continue wearing the finger cover 2 while they type or perform other computer tasks. When the user is done with their friction free (or at least a low friction) operation of a touch screen 19, 20, & 24 they can remove the finger covers 2 and place them in a convenient travel storage pouch.

There are other ways to implement friction eliminating or reducing methods of operation for capacitive or pressure touch screens which include:
One alternate approach places a specialized protective layer of material 56 over the screen 20 of a smart phone/PDA device 22 which is made from a friction reducing material, like silicone, to reduce (not eliminate) the friction between the user's finger tips 6 and the said cell phone/PDA device 22.
Another alternative way to uniquely implement the core functionality of the main invention 2 is to attach a specialized finger cap 66, via a retractable string 64, to a plastic clamp 62 which articulates with the body of a touch screen equipped smart phone 22, computer tablet 26, PC monitor 21 or any other suitable electronic device. This facilitates prompt use of the friction eliminating finger cover 66 while allowing the user to remove the item 66 from their finger 15 while they're not manipulating the touch screen.
Yet another embodiment of the invention 2, which is not depicted in the drawings, allows the user to drop their finger 15 into the cover like a hotdog bun and then seal the top portion of the cover over their finger like a zip lock bag.
   One skill in the art will appreciate that many other embodiments can be used to implement the invention without departing from its scope defined in the appended claims;

I claim:

1. An apparatus for effecting one or more operations on a touch sensitive screen comprising:
at least one finger glove arranged and constructed to fit on a person's finger, said finger glove having a contact area positioned for contacting the touch sensitive screen, said contact area being made of a low friction material whereby reduced friction is perceived when the person moves his finger with the finger glove across the touch sensitive screen.

2. The apparatus of claim 1 comprising several finger gloves for respective fingers, each finger glove having a low friction contact area.

3. The apparatus of claim 1 wherein said finger glove is made of said low friction material.

4. The apparatus of claim 3 wherein said low friction material is selected from the group consisting of nylon, cotton, and a silicone base material.

5. The apparatus of claim 1 further comprising a securing member for securing the finger glove on the person's finger.

6. The apparatus of claim 5 wherein said securing member is one of a hook-and-loop fastener and an adhesive fastener.

7. A method of operating an electronic device having a touch screen comprising:
Providing at least one finger glove, said finger glove including an outside surface with a contact area; and
Installing said finger glove by a person;
Wherein said contact area is made of a material selected to provide low friction when the finger is moved across and is contact with said touch screen.
